(19) United States
(12) Patent Application Publication
(10) Pub. No.: US 2006/0162599 A1
(43) Pub. Date: Jul. 27, 2006

(54) Method and device for feeding dampening water in offset printing press

(75) Inventor: Junzo Nagashima, Machida-shi Tokyo (JP)

Correspondence Address: YOUNG & THOMPSON, 745 SOUTH 23RD STREET, 2ND FLOOR, ARLINGTON, VA, 22202, US

(73) Assignee: YUGEN KAISHA ADVANCED ENGINEERING, TOKYO (JP)

(21) Appl. No.: 10/523,699

(22) PCT Filed: Dec. 25, 2003
(86) PCT No.: PCT/JP03/16812

§ 371 Date: Feb. 3, 2005

(30) Foreign Application Priority Data
Dec. 26, 2002 (JP) 2002-377104
May 27, 2003 (JP) 2003-149186

(51) Int. Cl. B41F 33/00

(52) U.S. Cl. 101/484

(57) ABSTRACT

A method of feeding appropriate dampening water in an offset printing press, comprising the steps of detecting the viscosity of dampening water at room temperature, selectively adding at least two of water and a surface active agent to the dampening water so that the viscosity of the dampening water becomes a target value, and feeding the dampening water having the target viscosity to the offset printing press at the room temperature, whereby since the viscosity of the dampening water (13) can be brought near into the target value suitable for printing by adding water or the surface active agent to the dampening water (13), the dampening water (13) can be fed at the room temperature without heating or cooling the dampening water.

### FIELD OF THE INVENTION

The present invention relates to a method and apparatus for supplying dampening solution in an offset printing machine.

### RELATED ART

In an offset printing technique, in order to selectively apply an ink on a printing area of a printing plate on the same plane by utilizing a repulsion action of water and oil based ink, a dampening solution (or water) is first applied uniformly on an entire surface of a printing plate by using a dampening solution supply device and, then, the ink is applied on the entire surface of the printing plate by using ink rollers. In such treatment, since hydrophilic working is made to a non-printing area of the printing plate, and on the other hand, lipophilic working is made to the printing area, a thin film of the dampening solution is formed on the non-printing area without being applied with the ink, and the ink is only applied to the printing area. The ink on the printing area on the printing plate is once transferred to a rubber surface of a blanket cylinder, and thereafter, transferred as an image on a printing paper, i.e., web, passing a gap between the blanket cylinder and an impression cylinder.

As mentioned above, in the offset printing, the dampening solution is used, and in such dampening solution, an etching solution (etchant) as weak acid solution is added so as to desensitize the printing area of the printing plate toward oil. It is generally considered to be proper for dampening solution to have a pH value in a range of 4.5 to 6.5. In a case of the pH value being less the above range (i.e., hydrogen ion concentration increases), the printing plate is etched, and a usable life thereof is thus shortened, and on the contrary, in a case of the pH value being over such range (i.e., hydrogen ion concentration decreases), an ability of desensitising the printing area is reduced or there causes a fear of generation of emulsification of the ink, which may cause contamination in printing (printing contamination) on the printing plate. In general, in order to make stable the printing quality, the concentration of the etchant is controlled with the pH value being index.

Moreover, it is required for the dampening solution to be spread as thin film on the non-printing area on the printing plate. Accordingly, in a conventional art, a surface active agent, such as alcohol group of isopropyl-alcohol, ethyl-alcohol, or like, for example, is added to the dampening solution so that the dampening solution is uniformly spread on the non-printing area of the printing plate. Another surface active agent such as ethyl-glycol may be utilized in substitution for the alcohol group.

However, even if the concentration of the etchant of the dampening solution is controlled with the pH value being index, in some cases, printing contamination will be inevitably caused. In such occasion, it is known through experience that the control or management of temperature of the dampening solution is important for stabilizing the printing quality. That is, in an event that the temperature of the dampening solution changes largely, the application or sticking of the dampening solution to the non-printing area also changes largely, and the nature of the ink is also changed, resulting in instable printing quality. For example, in a summer season, the temperature of the dampening solution rises in accordance with the rising of the atmospheric temperature, and hence, dampening solution retained to the non-printing area becomes non-uniform in amount, which will likely result in the causing of the printing contamination. By controlling the temperature of the dampening solution, the dampening solution can be spread entirely on the non-printing area of the printing plate, and hence, the printing quality can be improved. Further, it is said to be desired to maintain the temperature of the dampening solution in a range of 9 to 15° C.

In a conventional technology, in order to manage the pH value and temperature of the dampening solution, a dampening solution automatic adjusting apparatus has been utilized. Such dampening solution automatic adjusting apparatus performs a pH adjustment of the dampening solution by adding an etchant or water to the dampening solution in a dampening solution adjustment tank in response to a signal from a pH detector disposed in the dampening solution adjustment tank and also performs a dampening solution temperature adjustment by operating a freezer or heater in response to a signal from a temperature measuring device (for example, as disclosed in Japanese Patent Publication No. SHO 60-3994).

Further, the conventional dampening solution adjusting method and apparatus for controlling or managing the pH value and the temperature of the weak acid dampening solution to be made constant may involve the following defects.

(1) Since the temperature of the dampening solution is to be controlled, a freezer and a heater are driven throughout a year, which involves an increased power consumption.

(2) Since a power source, i.e., heating source, for such freezer and heater is arranged near a printing machine, an environmental condition around a working place will be made worse, particularly, in the summer season.

(3) Since the temperature of the dampening solution is controlled, it is necessary to circulate the dampening solution between a water storing portion, as dampening fountain, of a dampening solution device disposed in the offset printing machine and a temperature control unit so as to cool or heat the dampening solution, and for this purpose, it is necessary to always drive a circulation pump.

(4) Since the dampening solution contacts an ink roller, the dampening solution is contaminated with an ink, a solvent or like always circulates between the dampening fountain and the temperature control unit, so that a filter is needed for filtrating the contaminated dampening solution.

(5) Since dew is likely formed to a dampening solution supply passage, particularly in the summer season, at which there is a large difference in temperature between the dampening solution temperature and a room temperature in a printing room, it is necessary to shut off a circulation water conduit or pipe, dampening fountain and the like between the printing machine and the temperature control unit by using an insulating member. In addition, in an event that the insulation is not made or insulating member is peeled off, the dew may drop down on a printing paper and prevent the transfer of the ink, deteriorating the printing quality, thus being inconvenient.

(6) The dampening solution adjusting apparatus is itself expensive and it is usually necessary to locate one dampening solution adjusting apparatus for the printing machine in consideration of the capacities of the freezer and the heater, which involves increased printing cost and maintenance cost, thus providing problems.

(7) Since the contaminated dampening solution circulates, it is necessary to change a filter or periodically clean the dampening solution tank, inspection or maintenance thereof is troublesome, thus being inconvenient.

In order to obviate the defects or drawbacks mentioned above, an object of the present invention is therefore to provide a dampening solution supply method and apparatus for an offset printing machine.

### DISCLOSURE OF THE INVENTION

Hereunder, the present invention will be described. Further, to make easy the understanding of the present invention, although reference numerals used on accompanying drawings are added with parentheses, the present invention is not limited thereby to embodiments described on the drawings.

The inventors of the subject application was conceived to use a dampening solution of normal temperature to solve the problems or defects encountered in the prior art and performed repeated tests by using an actual apparatus or like with the dampening solution of room temperature, and through such tests, the following matters were found out.

(1) As can be seen from FIG. 3, when the temperature of the dampening solution exceeds 18° C. or near, viscosity of the dampening solution is deteriorated, the amount of the dampening solution held on the surface of printing plate becomes uneven, which will result in partial shortage of the dampening solution amount on the plate surface and hence cause contamination thereon. This undesired matter is solved by preliminarily increasing the viscosity of the dampening solution, even at a temperature of the dampening solution of 40° C., for example, so as to maintain the viscosity to a value of an extent to that at a temperature of the dampening solution of 16° C. Further, although the addition of the etchant (etching solution) for increasing the viscosity of the dampening solution may results in an excessive increasing of the pH value, this matter will be solved by increasing the viscosity thereof by adding an additive which does not or less give an influence to the pH value. Otherwise, this matter may be solved by adding a surface active agent or viscosity increasing agent. The viscosity increasing agent may be contained in the etchant, but it may be added independently from the etchant so as to increase the viscosity. That is, the printing quality is significantly related to the viscosity of the dampening solution itself more than the temperature thereof, and accordingly, it becomes possible to maintain constant the solution film thickness on the plate surface, even if the temperature of the dampening solution changes, by measuring the viscosity of the dampening solution and then adding a viscosity increasing agent, as additive, such as ethylene-glycol so as to keep the viscosity of the dampening solution to a predetermined value.

(2) Concerning the pH value, because chemical reaction is activated in accordance with the increase of the temperature, the acidity is weakened to the alkaline side and the pH value is hence increased. However, this matter will be solved by properly adding water or etchant.

The present invention was conceived in consideration of the above knowledge and findings, and the invention according to claim 1 provides a dampening solution supplying method for an offset printing machine which comprises the steps of detecting a viscosity of a dampening solution at a normal temperature, selectively adding at least water and surface active agent to the dampening solution so as to obtain an aimed value of the viscosity of the dampening solution, and supplying the dampening solution having the aimed viscosity to an offset printing machine at the normal temperature.

The invention of claim 2 provides a method of supplying a dampening solution for an offset printing machine which comprises the steps of detecting a viscosity of a dampening solution at a normal temperature, selectively adding at least water, surface active agent or viscosity increasing agent (31) to the dampening solution so as to obtain an aimed value of the viscosity of the dampening solution, and supplying the dampening solution having the aimed viscosity to an offset printing machine at the normal temperature.

Furthermore, the invention of claim 3 provides a method of supplying a dampening solution for an offset printing machine which comprises the steps of detecting a viscosity of a dampening solution (13) at a normal temperature, selectively adding at least water, etchant (etching solution) (18) and viscosity increasing agent to the dampening solution (13) so as to obtain aimed pH value and aimed viscosity of the dampening solution, and supplying the dampening solution (13) having the aimed pH value and aimed viscosity to an offset printing machine at the normal temperature.

The invention of claim 4 is a method of supplying a dampening solution for an offset printing machine according to any one of claims 1 to 3, in which the dampening solution (13) is additionally supplied to the offset printing machine by an amount corresponding to a consumed amount through one-way manner.

Moreover, the invention of claim 5 provides an apparatus for supplying a dampening solution for an offset printing machine which comprises a mixing tank (14) for adjusting a dampening solution at a normal temperature, a viscosity measuring unit (35) for measuring a viscosity of the dampening solution (13) in the mixing tank, an adding unit (36) for selectively adding at least water and surface active agent to the dampening solution in the mixing tank so as to obtain an aimed viscosity, and a supply unit for supplying the dampening solution having the aimed viscosity to an offset printing machine at the normal temperature.

The invention of claim 6 provides an apparatus for supplying a dampening solution for an offset printing machine which comprises a mixing tank (14) for adjusting a dampening solution at a normal temperature, a viscosity measuring unit (35) for measuring a viscosity of the dampening solution (13) in the mixing tank, an adding unit (32, 36) for selectively adding at least water, surface active agent and viscosity increasing agent (31) to the dampening solution in the mixing tank so as to obtain an aimed viscosity, and a supply unit for supplying the dampening solution having the aimed viscosity to an offset printing machine at the normal temperature.

Furthermore, the invention of claim 7 provides an apparatus for supplying a dampening solution for an offset printing machine which comprises a mixing tank (14) for adjusting a dampening solution at a normal temperature, a pH concentration measuring unit (29) for measuring pH value of the dampening solution (13) in the mixing tank, a viscosity measuring unit (35) for measuring a viscosity of the dampening solution in the mixing tank, an adding unit (36, 26, 32) for selectively adding at least water, etchant and viscosity increasing agent (31) to the dampening solution in the mixing tank so as to obtain aimed pH value and aimed viscosity, and a supply unit (44) for supplying the dampening solution (13) having the aimed pH value and aimed viscosity to an offset printing machine at the normal temperature.

The invention of claim 8 provides an apparatus for supplying a dampening solution for an offset printing machine according to any one of claims 5 to 7, in which the supply unit for supplying the dampening solution (13) to the offset printing machine is provided with a one-way conduit (44) connecting the mixing tank (14) to a dampening fountain (5), a water-level meter (45) for detecting water-level of the dampening solution in the dampening fountain, and a valve (46) for additionally supplying the dampening solution to the dampening fountain (5) by opening the one-way conduit (44) in response to a signal from the water-level meter (45).

### BRIEF DESCRIPTION OF THE DRAWINGS

FIG. 1 is schematic side view of one unit of an offset printing machine.

FIG. 2 is a system diagram showing a dampening solution supplying device according to a first embodiment 1 of the present invention.

FIG. 3 shows a graph representing a relationship between viscosity and temperature of the dampening solution.

FIG. 4 is a system diagram showing a dampening solution supplying device according to a second embodiment 2 of the present invention.

FIG. 5 is a system diagram showing a dampening solution supplying device according to a third embodiment 3 of the present invention.

### BEAT MODE FOR EMBODYING THE INVENTION

Hereunder, respective embodiments of the present invention will be described.

### First Embodiment 1

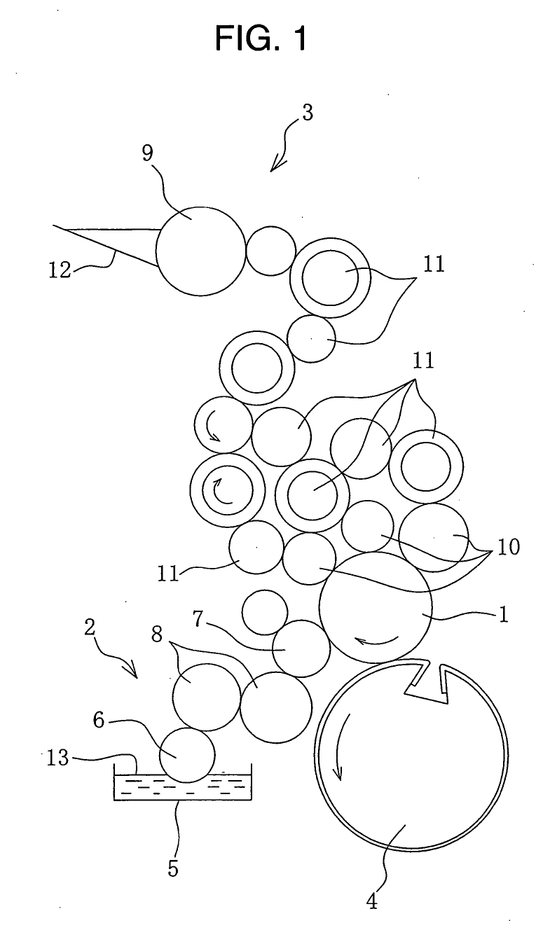

As shown in FIG. 1, an offset printing machine (or press) is provided with a dampening solution transferring device 2, an ink transferring device 3 and a blanket cylinder 4, which are arranged around a plate cylinder 1 as rollers in rotating direction thereof. The number of units and the arrangements thereof are of course different according to the types of the printing machines.

The dampening solution transferring device 2 is provided with a water (solution) boat 5 storing the dampening solution, a dampening roller 6 contacting the dampening solution in the dampening fountain 5, a printing plate, not shown, wound around the plate cylinder 1, an dampening form roller 7 contacting the plate surface of the printing plate, and a single or a plurality of intermediate rollers 8 arranged between both the rollers 6 and 7. According to the rotating of the dampening fountain roller 6, the dampening solution is taken out from the dampening fountain 1, transferred to the dampening form roller 7 through the intermediate rollers 8 and then transferred to the surface of the plate cylinder 1 through the dampening form roller 7. During such operation, the solution in the dampening fountain 1 adheres, as thin film, to the surface of the plate cylinder 1 through the dampening fountain roller 6, the intermediate roller(s) 8 and the dampening form roller 7.

The ink transferring device 3 is provided with a fountain roller 9 contacting an ink fountain 12, a form roller 10 contacting the surface of the plate cylinder 1 and a plurality of ink distributing rollers 11 arranged between the fountain roller 9 and the form roller 10. The ink in the ink fountain 12 is drawn out by the rotation of the fountain roller 9, the ink is then transferred to the form roller 10 while being kneaded by the intermediate ink distributing rollers 11, and the ink is transferred to the surface of the plate cylinder 1 from the form roller 10. In such ink transferring device 3, rollers shown with a single circle in FIG. 1 are rubber rollers of which surfaces are covered with rubber, and rollers shown with double circles in FIG. 1 are metal rollers of which surfaces are covered with metal. The ink in the ink fountain 12 adheres as thin film on the surface of the plate cylinder 1 through the fountain roller 9, the intermediate ink distribution rollers 11 and the form roller 10. Further, in this process, since the dampening solution had already been applied to the hydrophilic non-printing area of the surface of the plate cylinder 1, the ink is adhered on the lipophilic printing area as thin film.

A rubber sheet is wound around the outer surface of the blanket cylinder 4, and the ink adhering on printing area of the plate surface of the plate cylinder 1 is transferred and adheres to the surface of this rubber sheet. To this blanket cylinder 4, an impression cylinder, not shown, or another blanket cylinder contacts, and the ink on the blanket cylinder 4 is transferred onto printing paper, i.e., web, passing through the blanket cylinder 4 and the impression cylinder, thus performing the printing operation.

The dampening solution is fed to the dampening solution transferring device 2 by dampening solution supplying method and apparatus, which will be described hereunder.

The dampening solution supplying method utilizes, as mentioned before, the facts that the thickness of the water film on the plate surface can be maintained constant, even if solution temperature changes, by adding water or viscosity increasing agent in the dampening solution so as to approach the viscosity of the dampening solution to a predetermined value, and that the problem concerning the pH value of the dampening solution can be solved by properly adding the water or etchant to the dampening solution. Accordingly, in this method, the viscosity of the dampening solution at a normal temperature is detected, at least water, etchant and viscosity increasing agent are selectively added to the dampening solution so that the pH value and viscosity of the dampening solution reach the predetermined aimed values, respectively, and then, the dampening solution of the aimed pH value and viscosity is supplied at a normal temperature to an offset printing machine.

Furthermore, in this dampening solution supplying method, it is desired that the dampening solution is additionally supplied of the amount corresponding to its consumed amount in one-way supply manner in the offset printing machine without circulating the dampening solution therein.

The dampening solution mentioned herein is prepared by diluting the etchant (or etching solution) by, for example, 30 to 50 times with water of normal temperature, and the pH value desirable for maintaining the printing quality is, for example, 4.5 to 6.5, which may differ in types of printing papers, printing areas, inks, plate cylinders, and the like. Further, the desirable viscosity is around 1.3 poise.

The etchant has a composition different in accordance with the kinds of the printing plates, and for example, includes weak acid such as phosphoric acid, chromic acid, or tannic acid, salts of such acids, colloidal matter such as gum Arabic, or surface active agent such as ethylene glycol.

As the viscosity increasing agent, a material which has no relation to the increasing of the pH value, i.e., which does substantially not or less affects on the change of the pH value, is selected, and for example, ethylene glycol as surface active agent may be used.

As the water for diluting the etchant or like, tap water of a normal temperature will be utilized in the present embodiment. Although there may cause a case that if calcium component contained in the tap water is piled on the rubber surface of the dampening solution transfer roller or the ink roller, the function of the roller may be deteriorated, in order to prevent such defect, a known demineralizer may be provided as occasion demands for a tap water pipe.

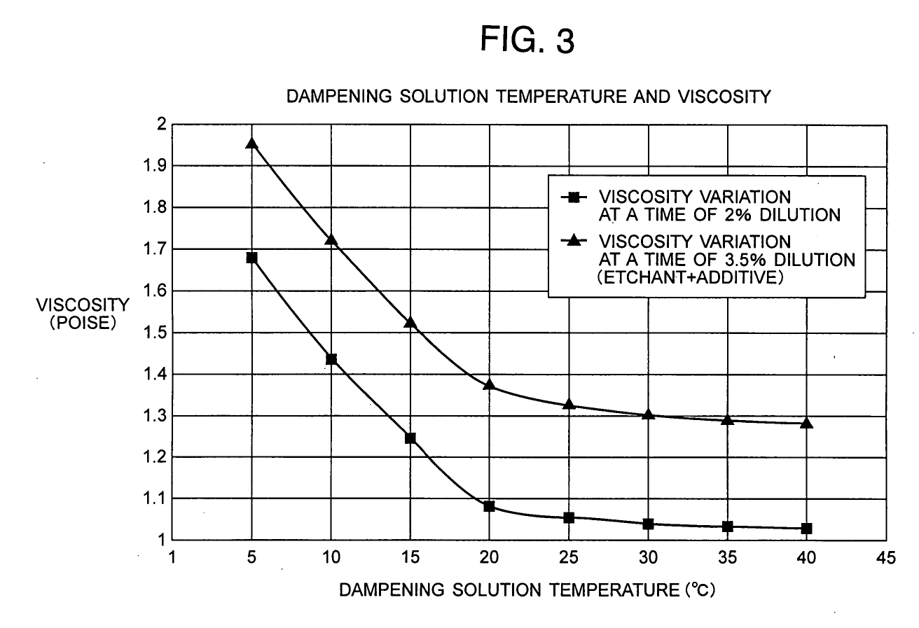

As mentioned above, since the viscosity of the dampening solution approaches to the aimed viscosity value suitable for the printing, the dampening solution can be supplied to the offset printing machine without being heated or cooled at a normal temperature. For example, in a case where an ambient temperature increases and the viscosity of the dampening solution is hence reduced, it may be considered that the etchant is added to the dampening solution to increase its viscosity. However, according to such addition, the pH value of the dampening solution may decrease to the acid side and ability of desensitisation excessively increases, and such a phenomenon as that the ink does not adhere to the printing area portion will be caused. Taking this matter into consideration, in the present invention, the viscosity increasing agent, which has no influence to the increasing of the pH value, is added independent from the addition of the etchant to thereby increase the viscosity of the dampening solution as shown in FIG. 3. In FIG. 3, since, as shown with the curve at the time of 3.5% dilution, the dampening solution provides the viscosity of the value of 1.3 at the temperature of 30° C., the dampening solution can evenly spread on the non-printing area of the printing plate or cylinder and any contamination in printing is not caused thereon. Moreover, in a case where the pH value changes in response to the change in atmospheric temperature, the pH value can be kept to the predetermined value by adding the water or etchant to the dampening solution.

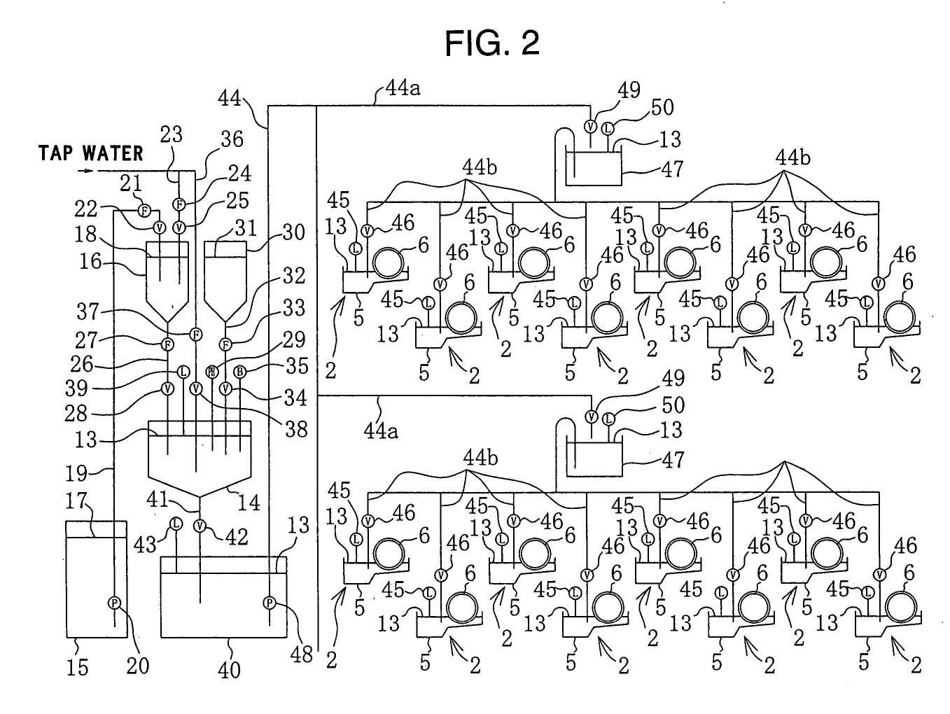

The dampening solution supplying method for the offset printing machine of the characters mentioned above will be executed by using a dampening solution supplying apparatus shown in FIG. 2.

As shown in FIG. 2, the dampening solution supplying apparatus includes a mixing tank 14 in which the dampening solution 13 is adjusted at a normal temperature, a pH concentration measuring unit for measuring the pH value of the dampening solution 13 in the mixing tank 14, a viscosity measuring unit for measuring the viscosity of the dampening solution 13 in the mixing tank 14, an adding unit for selectively adding at least water, etchant and viscosity increasing agent to the dampening solution 13 in the mixing tank 14 so as to obtain aimed pH value and viscosity, and dampening solution supplying unit for supplying, at the normal temperature, the dampening solution 13 having the aimed pH value and viscosity to the offset printing machine.

The mixing tank 14 is a vessel for diluting and mixing the etchant with water, and it is desired for the etchant to be prepared by diluting an etchant having high concentration into an etchant having low concentration, which is then supplied into the mixing tank 14.

A primary solution tank 15 of the etchant and a secondary solution tank 16 of the etchant are arranged on an upstream side of the mixing tank 14. In the primary solution tank 15, an etchant 17 having a high concentration is stored, and on the other hand, in the secondary solution tank 16, an etchant 18 having a low concentration is stored. The etchant 17 of the high concentration in the primary solution tank 15 is fed to the secondary solution tank 16 through a duct or conduit 19 extending from the primary solution tank 15 to the secondary solution tank 16. A pump 19, a flow-meter 21 and an electromagnetic valve 22 are provided for this conduit 19. A tap water pipe 23 is connected to the secondary solution tank 16, and a flow-meter 24 and an electromagnetic valve 25 are provided for this tap water pipe 23. A conduit 26 extends from the secondary solution tank 16 to the mixing tank 14 as etchant adding member so as to supply the etchant of low concentration 18, and a flow-meter 27 and an electromagnetic valve 28 are provided for this conduit 26. A pH concentration meter 29 is also provided for the mixing tank 14 as a pH concentration measuring unit for measuring the pH value of the dampening solution in the mixing tank 14.

The primary solution tank 15 has, for example, a volume of more than 200 litters, and the etchant 17 having a high concentration higher than that of commercially sold conventional etchant is stored in this primary solution tank 15, and a constant amount, 10 litters, for example, of the etchant 17 is fed to the secondary solution tank 16 by the operation of the pump 20. On the other hand, in the secondary solution tank 16, the tap water of a constant amount of, for example, 30 litters, is added to the primary etching solution 17 to prepare the secondary etching solution 18 of 25% concentration, for example. Further, the primary etching solution 17 will be agitated automatically by a feeding pressure of the tap water. As mentioned above, in the present invention, since the etchant is subsequently fed to the mixing tank 14 by gradually diluting its concentration, the mixing solution of the etchant can be effectively prepared in the mixing tank 14.

The etchant 18 in the secondary solution tank 16 is successively fed to the mixing tank 14 through the conduit 26 by opening the electromagnetic valve 28 till the dampening solution in the mixing tank 14 indicate the aimed pH value by the pH concentration meter 29. Upon reaching to the aimed pH value, the electromagnetic valve 28 is closed and the etchant flow is shut off.

A viscosity increasing agent tank 30 is disposed on the upstream side of the mixing tank 14. A conduit 32 extends downward, as viscosity increasing agent supply member, from the viscosity increasing agent tank 30 towards the mixing tank 14, and a flow-meter 33, and an electromagnetic valve 34 are provided for this conduit 32. An electric resistance value concentration meter 35 is disposed in the mixing tank 14, as viscosity measuring member, for measuring the viscosity of the damping solution at a normal temperature in the mixing tank 14. Since it is considered that the concentration of the dampening solution 13 and the viscosity are corelated, the concentration measured by the electric resistance value concentration meter 35 is utilized for the viscosity in this embodiment. The viscosity increasing agent 31 in the viscosity increasing agent tank 30 is fed to the mixing tank 14 by opening the electromagnetic valve 34, and upon detecting the aimed viscosity by the electric resistance value concentration meter 35, the electromagnetic valve 34 is closed and the addition of the viscosity increasing agent is shut off.

A conduit 36 is further connected to the mixing tank 14 as a tap water adding member, and a flow-meter 37 and an electromagnetic valve 38 are provided for this conduit 36. By opening or closing the electromagnetic valve 38 under observation of the flow-meter 37, the tap water flows in the mixing tank 14 by a predetermined amount at a normal temperature. The flow-in amount of the tap water into the mixing tank 14 is detected by a water-level meter 39 provided for the mixing tank 14.

A water-distribution tank or merely distribution tank 40 for storing the dampening solution 13 prepared in the mixing tank 14 at the normal temperature is arranged on a downstream side of the mixing tank 14. The mixing tank 14 and the water-distribution tank 40 are communicated through a conduit 41 to which an electromagnetic valve 42 is arranged. When the electromagnetic valve 42 is opened, the dampening solution in the mixing tank 14 flows by the predetermined amount. The flow-in amount of the dampening solution 13 into the distribution tank 40 is detected by a water-level meter 43, and upon detecting the reaching to the predetermined level, the electromagnetic valve 42 is closed and the flow-in of the dampening solution 13 is then shut off.

In the described embodiment, two sets of blanket-to-blanket type four-color offset printing machines are disposed, and as shown in FIG. 2, the dampening solution 13 in the water-distribution tank is supplied to the dampening solution transferring devices 2 of the respective offset printing machines through predetermined supply units or like. It is of course possible to directly supply the dampening solution 13 to the offset printing machines.

These supply units includes a one-way conduit 44 connecting the distribution tank 40 disposed downstream side the mixing tank 14 to the dampening fountains 5 of the dampening solution transferring devices 2, water-level detectors 45 for detecting the water level of the dampening solution 13 in the dampening fountains 5, and electromagnetic valves 46 which acts to open the one-way conduit 44, in response to a signal from the water-level meter 45 indicating the lowering of the water-level of the dampening solution 13, to thereby supply the dampening solution 13 to the respective dampening fountains 5.

The one-way conduit 44 is provided with main conduits 44a extending from the water-distribution tank 40 to the respective printing machines, buffer tanks 47 connected to these main conduits 44a and adopted to store the dampening solution 13 fed through the main conduits 44a, and branch conduits 44b extending from the buffer tanks 47 to the dampening fountains 5, respectively.

The main conduits 44a extend from the water-distribution tank 40 to the respective buffer tanks 47 to supply the dampening solution pumped up by a pump 48 provided on the side of the distribution tank 40. The main conduits 44a are provided with electromagnetic valves 49 for the respective buffer tanks 47, and when water-level meters 50 provided for the respective buffer tanks 47 detect predetermined water levels, the electromagnetic valves 49 are closed to thereby shut off the flow of the dampening solution. The buffer tanks 47 are arranged on a level higher than the location of the dampening fountains 5 on the side of the printing machines, and accordingly, the dampening solution can be fed from the buffer tanks 47 to the dampening fountains 5 in accordance with the siphon theory.

Further, the electromagnetic valves 46 are provided for the branch conduits 44b connected to the front ends of the main conduits 44a, and in response to signals from the water-level meters 45 for the respective dampening fountains 5, these electromagnetic valves 46 are opened or closed to thereby supply the dampening solution 13 to the dampening fountains 5. That is, the dampening solution 13 of the amount corresponding to the amount consumed in the printing machines is supplied from the buffer tanks 47 to the dampening fountains 5, respectively. Further, since the dampening solution 13 is supplied at the normal temperature to the branch conduits 44b, there is no fear of dewing of the dampening solution during the supply, so that any heat insulation is not made to the main conduits 44a and the branch conduits 44b.

Next, the function or operation of the dampening solution supplying apparatus of the structure mentioned above will be described hereunder.

As shown in FIG. 2, the etchant 17 in the primary solution tank 15 is fed to the secondary solution tank 16 together with the tap water and mixed therein to thereby prepare the etchant 18 having a low concentration. The thus prepared etchant 18 of low concentration is adjusted at the normal temperature through the open/close operation of the electromagnetic valves 22 and 25 controlled in response to the signals from the flow-meters 21 and 24.

The etchant 18 of low concentration is fed at the normal temperature to the mixing tank 14, in which it is mixed with the tap water and the viscosity increasing agent 31 to thereby prepare the dampening solution 13. In this operation, the dampening solution 13 having the viscosity and pH value suitable for the printing operation can be adjusted and prepared, regardless of the change of the atmospheric temperature and the like, by the operations of the water-level meter 39, the pH concentration meter 29, the electric resistance value concentration meter 35 and the various electromagnetic valves 28, 34 and 38. More specifically, the tap water of predetermined constant amount is at first fed into the mixing tank 14, and then, the viscosity increasing agent 31 is added thereto from the viscosity increasing agent tank 30 in accordance with the water temperature in the normal ambient temperature (that is, a large amount of viscosity increasing agent is added at a time of high water temperature and a small amount thereof is added at a time of low water temperature). That is, the viscosity increasing agent 31 is added till the viscosity detected by the electric resistance concentration meter 35 will have reached a viscosity appropriate to the printing operation at the water temperature at that time. In addition, the etchant 18 is dropped into the mixing tank 14 from the secondary solution tank 16 till the pH value will have reached a value appropriate to the printing operation and is then mixed with the viscosity increasing agent 31 and the tap water as diluting solution in the mixing tank 14. That is, the etchant 18 is added till the pH value detected by the pH concentration meter 29 will have reached to a pH value appropriate to the printing operation at that water temperature.

The dampening solution 13 adjusted to have the aimed viscosity and pH value is transferred to the distribution tank 40 from the mixing tank 14. In this operation, when the distribution tank 40 is filled up with the dampening solution, the dampening solution 13 in the mixing tank 14 is reserved as it is therein. Thus, the distribution of the dampening solution 13 to the printing machine can be prevented before the settling of the viscosity and the pH value, and accordingly, the always stable dampening solution can be distributed to the printing machine.

The dampening solution 13 in the distribution tank 40 is fed to the printing machine through the buffer tank 47 and the main conduits 44a, and thereafter, is fed to the water boasts 5 of the respective dampening solution transferring devices 2 of the printing machine via the branch conduits 44b connected to the respective main conduits 44a.

As shown in FIG. 1, when the printing machine is driven, the dampening rollers 6 are rotated in the respective dampening fountains 5 to draw up the dampening solution from the dampening fountains 5, and the dampening solution is transferred to the dampening form rollers 7 through the intermediate rollers 8 and then transferred to the plate cylinder 1 from the dampening form rollers 7. Thus, as mentioned above, the dampening solution 13 adheres in form of thin film on the plate cylinder 1 through rotations of the intermediate rollers 8 and the dampening form rollers 7.

On the other hand, the fountain roller 9 is rotated to thereby draw out the ink from the ink fountain 12, and the ink is kneaded by the intermediate ink distributing rollers 11 and transferred to the surface of the plate cylinder 1 by means of the form roller 10. Thus, the ink adheres in form of thin film on the surface of the plate cylinder 1 through the rotations of the fountain roller 9, the ink distributing rollers 11 and the form roller 10.

The blanket cylinder 4 contacts the plate cylinder 1 and the impression cylinder or another blanket cylinder, not shown, contacts this blanket cylinder 4 in a manner that the ink transferred from the plate cylinder 1 to the blanket cylinder 4 is then transferred to the printing paper, i.e., web, passing a gap between the blanket cylinder 4 and the impression cylinder, thus performing the printing to the printing paper.

In accordance with the progress of the printing operation, the dampening solution in the dampening fountains 5 is consumed, and when the water-level meter 45 detects the lowering of the water-level of the dampening solution 13 in the boat 5, the electromagnetic valve 46 provided for the branch conduit 44b is opened to thereby compensate for the dampening solution 13 in the dampening fountain 5. Further, when the water level in the buffer tank 47 is lowered, the pump 48 is operated in response to the signal form the water-level meter 50 to supply the dampening solution 13 to the respective buffer tanks 47 from the distribution tank 40, respectively.

### Second Embodiment 2

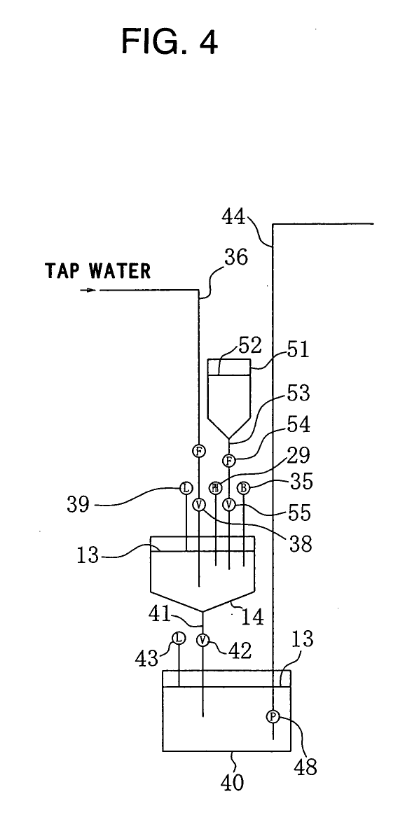

As shown in FIG. 4, the dampening solution supplying apparatus of an offset printing machine of this second embodiment 2 includes a mixing tank 14 in which the dampening solution 13 is adjusted at a normal temperature, a viscosity measuring unit for measuring the viscosity of the dampening solution 13 in the mixing tank 14, an adding unit for selectively adding at least water and surface active agent to the dampening solution 13 in the mixing tank 14 so as to obtain aimed viscosity, and a dampening solution supplying unit for supplying, at the normal temperature, the dampening solution 13 having the aimed viscosity to the offset printing machine.

A surface active agent tank 51 is disposed on the upstream side of the mixing tank 14. A conduit 53 is suspended, as adding member for surface active agent 52, from the surface active agent tank 51 towards the mixing tank 14, and a flow-meter 54 and an electromagnetic valve 55 are provided for the conduit 53. An electric resistance value concentration meter 35, as viscosity measuring member, for measuring the viscosity of the dampening solution 13 at the normal temperature in the mixing tank 14 is disposed therein. In this embodiment, since the concentration of the dampening solution and the viscosity thereof are considered to be correlated, the concentration measured by the electric resistance value concentration meter 35 is utilized as viscosity. When the electromagnetic valve 55 of the conduit 53 is opened, the surface active agent 52 in the surface active agent tank 51 flows into the mixing tank 14, and when the electric resistance value concentration meter 35 detects the aimed viscosity, the electromagnetic valve 34 is closed to thereby shut off the addition of the surface active agent 52.

According to the manner mentioned above, the viscosity of the dampening solution 13 in the mixing tank 14 is measured by the electric resistance value concentration meter 35, and the water or surface active agent is added. Accordingly, since the viscosity of the dampening solution 13 approaches to the aimed viscosity appropriate to the printing operation, the dampening solution can be supplied to the printing machine at the normal temperature without being heated or cooled, thus performing the appropriate printing operation.

### Third Embodiment 3

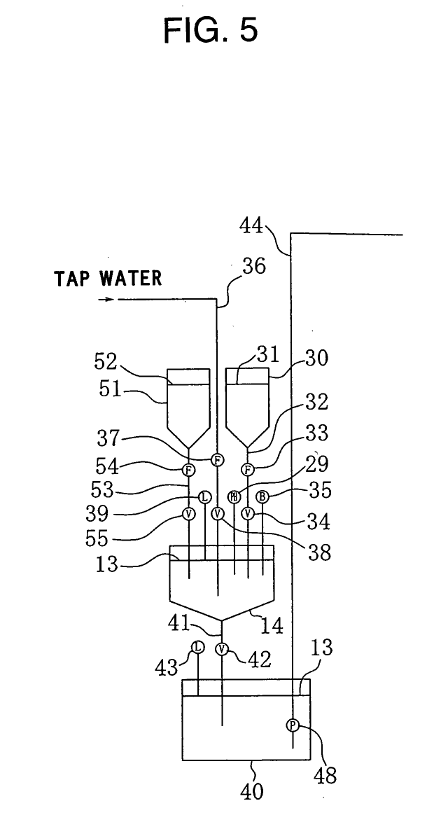

As shown in FIG. 5, the dampening solution supplying apparatus of an offset printing machine of this third embodiment includes a mixing tank 14 in which the dampening solution 13 is adjusted at a normal temperature, a viscosity measuring unit for measuring the viscosity of the dampening solution 13 in the mixing tank 14, an adding unit for selectively adding at least water, surface active agent 52 and viscosity increasing agent 31 to the dampening solution 13 in the mixing tank 14 so as to obtain aimed viscosity, and a dampening solution supplying unit for supplying, at the normal temperature, the dampening solution 13 having the aimed viscosity to the offset printing machine.

A surface active agent tank 51 and a viscosity increasing tank 30 are disposed on the upstream side of the mixing tank 14. A conduit 53 is suspended, as adding member for surface active agent 52, from the surface active agent tank 51 towards the mixing tank 14, and a flow-meter 54 and an electromagnetic valve 55 are provided for the conduit 53. In addition, a conduit 32 is suspended, as adding member for the viscosity increasing agent 31, from the viscosity increasing agent tank 30 towards the mixing tank 14, and a flow-meter 33 and an electromagnetic valve 34 are provided for this conduit 32.

An electric resistance value concentration meter 35, as viscosity measuring member, for measuring the viscosity of the dampening solution 13 at the normal temperature is disposed in the mixing tank 14. In this embodiment, since the concentration of the dampening solution and the viscosity thereof are considered to be correlated, the concentration measured by the electric resistance value concentration meter 35 is utilized as viscosity. When the electromagnetic valve 55 of the conduit 53 is opened, the surface active agent 52 in the surface active agent tank 51 flows into the mixing tank 14 and when the electromagnetic valve 34 of the conduit 32 is opened, the viscosity increasing agent 31 in the viscosity increasing agent tank 30 flows into the mixing tank 14. When the electric resistance value concentration meter 35 detects the aimed viscosity, the electromagnetic valves 55 and 34 are closed to thereby shut off the addition of the surface active agent 52 and the viscosity increasing agent 31.

According to the manner mentioned above, the viscosity of the dampening solution 13 in the mixing tank 14 is measured by the electric resistance value concentration meter 35, and the water, surface active agent and viscosity increasing agent are selectively added. Accordingly, since the viscosity of the dampening solution 13 approaches to the aimed viscosity appropriate to the printing operation, the dampening solution can be supplied to the printing machine at the normal temperature without being heated or cooled, thus performing the appropriate printing operation.

As mentioned hereinabove, in the dampening solution supplying method for the offset printing machine according to the present invention, the viscosity of the dampening solution at the normal temperature is detected, at least water and surface active agent are selectively added to the dampening solution to thereby obtain an aimed viscosity, and the dampening solution of the aimed viscosity is supplied to the offset printing machine at the normal temperature.

According to such method, since the viscosity of the dampening solution 13 approaches to the aimed value suitable for the printing operation by adding the water or surface active agent to the dampening solution 13, it can be supplied at the normal temperature without being heated or cooled.

Furthermore, in the dampening solution supplying method for the offset printing machine according to the present invention, the viscosity of the dampening solution at the normal temperature is detected, at least water, surface active agent and viscosity increasing agent are selectively added to the dampening solution to thereby obtain an aimed viscosity, and the dampening solution of the aimed viscosity is supplied to the offset printing machine at the normal temperature.

According to such method, since the viscosity of the dampening solution 13 approaches to the aimed value suitable for the printing operation by selectively adding the water, surface active agent and viscosity increasing agent to the dampening solution 13, it can be supplied at the normal temperature without being heated or cooled.

Still furthermore, in the dampening solution supplying method for the offset printing machine according to the present invention, the pH value and viscosity of the dampening solution at the normal temperature are detected, at least water, etchant 18 and viscosity increasing agent 31 is selectively added to the dampening solution to thereby obtain aimed pH value and viscosity, and the dampening solution of the aimed pH value and viscosity is supplied to the offset printing machine at the normal temperature.

According to such method, since the viscosity of the dampening solution 13 approaches to the aimed value suitable for the printing operation by selectively adding the water and viscosity increasing agent 31 to the dampening solution 13, it can be supplied at the normal temperature without being heated or cooled. In addition, the change in the pH value due to changing of the atmospheric temperature can be solved by adding the water or etchant 18. Accordingly, it is not necessary to locate any heating unit or cooling unit and also not necessary to perform heat insulation treatment for preventing dewing, so that energy saving, space saving, and improvement of ambient circumstances around the printing machine can be achieved.

Further, in the dampening solution supplying method of the present invention, the dampening solution may be supplied by an amount corresponding to the consumed amount through one-way supply means.

According to this manner, the dampening solution is supplied to the printing machine through one-way means and is not circulated, so that the circulation pump or filtrating filter is eliminated from locating.

On the other hand, the dampening solution supplying apparatus for the offset printing machine of the present invention includes the mixing tank 14 for adjusting the dampening solution at the normal temperature, the viscosity measuring member 35 for measuring the viscosity of the dampening solution 13 in the mixing tank 14, the adding member 36 for selectively adding the water and surface active agent to the dampening solution 13 in the mixing tank 14 so as to obtain the aimed viscosity of the dampening solution, and the supply unit for supplying the dampening solution of the aimed viscosity to the offset printing machine at the normal temperature.

According to this apparatus, since the viscosity of the dampening solution 13 can approach to the aimed value suitable for the printing operation by measuring the viscosity of the dampening solution 13 in the mixing tank 14 with the viscosity measuring member 35 and selectively adding the water and surface active agent with the adding member 36, the dampening solution 13 can be supplied at the normal temperature without being heated or cooled.

Furthermore, the dampening solution supplying apparatus for the offset printing machine of the present invention includes the mixing tank 14 for adjusting the dampening solution at the normal temperature, the viscosity measuring member 35 for measuring the viscosity of the dampening solution 13 in the mixing tank 14, the adding members 32, 36 for selectively adding the water, surface active agent and viscosity increasing agent 31 to the dampening solution 13 in the mixing tank 14 so as to obtain aimed viscosity of the dampening solution, and the supply unit for supplying the dampening solution of the aimed viscosity to the offset printing machine at the normal temperature.

According to this apparatus, since the viscosity of the dampening solution 13 can approach to the aimed value suitable for the printing operation by measuring the viscosity of the dampening solution 13 in the mixing tank 14 with the viscosity measuring member 35 and selectively adding the water, surface active agent and viscosity increasing agent 31 with the adding member 36, the dampening solution 13 can be supplied at the normal temperature without being heated or cooled.

Still furthermore, the dampening solution supplying apparatus for the offset printing machine of the present invention includes the mixing tank 14 for adjusting the dampening solution at the normal temperature, the pH concentration measuring member 29 for measuring the pH value of the dampening solution 13 in the tank 14, the viscosity measuring member 35 for measuring the viscosity of the dampening solution 13 in the mixing tank 14, the adding members 36, 26, 32 for selectively adding the water, etchant 18 and viscosity increasing agent 31 to the dampening solution 13 in the mixing tank 14 so as to obtain aimed pH value and viscosity of the dampening solution, and the supply unit for supplying the dampening solution of the aimed pH value and viscosity to the offset printing machine at the normal temperature.

According to this apparatus, since the viscosity of the dampening solution 13 can approach to the aimed value suitable for the printing operation by measuring the viscosity of the dampening solution 13 in the mixing tank 14 with the viscosity measuring member 35 and selectively adding the water and viscosity increasing agent 31 with the adding member 32 or 36, the dampening solution 13 can be supplied at the normal temperature without being heated or cooled. In addition, the change in the pH value due to changing of the atmospheric temperature can be solved by detecting the change of the pH value with the pH concentration measuring member 29 and adding the water or etchant 18 to the dampening solution 13 in the tank 14 with the adding member 36 or 26. Accordingly, it is not necessary to locate any heating unit or cooling unit and also not necessary to perform heat insulation treatment for preventing dewing, so that energy saving, space saving, and improvement of ambient circumstances around the printing machine can be achieved.

Further, in the dampening solution supplying apparatus of the present invention, the supply member for supplying the dampening solution 13 to the offset printing machine may be provided with the one-way conduit 44 connecting the mixing tank 14 to the dampening fountain 5, the water-level meter 45 for detecting the water-level of the dampening solution 13 in the mixing tank 14 and the valve 46 for compensating for the dampening solution 13 to the dampening fountain 5 in the opened state of the one-way conduit 44.

According to this arrangement, the dampening solution is additionally supplied into the dampening fountain 5 from the one-way conduit 44 under the control of the valve 46 while detecting the water-level, by the water-level meter 45, of the dampening solution 13 in the mixing tank 14, so that the dampening solution 13 is not circulated, and hence, the circulation pump or filtrating filter is eliminated from locating.

1. A method of supplying dampening solution for an offset printing machine comprising the steps of detecting a viscosity of a dampening solution at a normal temperature, selectively adding at least water and surface active agent to the dampening solution so as to obtain an aimed viscosity value of the dampening solution, and supplying the dampening solution having the aimed viscosity to an offset printing machine at the normal temperature.

2. A method of supplying a dampening solution for an offset printing machine comprising the steps of detecting a viscosity of a dampening solution at a normal temperature, selectively adding at least water, surface active agent and viscosity increasing agent to the dampening solution so as to obtain an aimed viscosity value of the dampening solution, and supplying the dampening solution having the aimed viscosity to an offset printing machine at the normal temperature.

3. A method of supplying a dampening solution for an offset printing machine comprising the steps of detecting a viscosity of a dampening solution at a normal temperature, selectively adding at least water, etchant and viscosity increasing agent to the dampening solution so as to obtain aimed pH value and aimed viscosity of the dampening solution, and supplying the dampening solution having the aimed pH value and aimed viscosity to an offset printing machine at the normal temperature.

4. The method of supplying a dampening solution for an offset printing machine according to claim 1, wherein the dampening solution is additionally supplied to the offset printing machine by an amount corresponding to a consumed amount thereof through one-way manner.

5. An apparatus for supplying a dampening solution for an offset printing machine comprising a mixing tank for adjusting a dampening solution at a normal temperature, a viscosity measuring unit for measuring a viscosity of the dampening solution in the mixing tank, an adding unit for selectively adding at least water and surface active agent to the dampening solution in the mixing tank so as to obtain an aimed viscosity, and a supply unit for supplying the dampening solution having the aimed viscosity to an offset printing machine at the normal temperature.

6. An apparatus for supplying a dampening solution for an offset printing machine comprising a mixing tank for adjusting a dampening solution at a normal temperature, a viscosity measuring unit for measuring a viscosity of the dampening solution in the mixing tank, an adding unit for selectively adding at least water, surface active agent and viscosity increasing agent to the dampening solution in the mixing tank so as to obtain an aimed viscosity, and a supply unit for supplying the dampening solution having the aimed viscosity to an offset printing machine at the normal temperature.

7. An apparatus for supplying a dampening solution for an offset printing machine comprising a mixing tank for adjusting a dampening solution at a normal temperature, a pH concentration measuring unit for measuring pH value of the dampening solution in the mixing tank, a viscosity measuring unit for measuring a viscosity of the dampening solution in the mixing tank, an adding unit for selectively adding at least water, etchant and viscosity increasing agent to the dampening solution in the mixing tank so as to obtain aimed pH value and aimed viscosity, and a supply unit for supplying the dampening solution having the aimed pH value and aimed viscosity to an offset printing machine at the normal temperature.

8. The apparatus for supplying a dampening solution for an offset printing machine according to claim 5, wherein the supply unit for supplying the dampening solution to the offset printing machine is provided with a one-way conduit connecting the mixing tank to a dampening fountain, a water-level meter for detecting water-level of the dampening solution in the dampening fountain, and a valve for additionally supplying the dampening solution to the dampening fountain by opening the one-way conduit in response to a signal from the water-level meter.

9. The apparatus for supplying a dampening solution for an offset printing machine according to claim 6, wherein the supply unit for supplying the dampening solution to the offset printing machine is provided with a one-way conduit connecting the mixing tank to a dampening fountain, a water-level meter for detecting water-level of the dampening solution in the dampening fountain, and a valve for additionally supplying the dampening solution to the dampening fountain by opening the one-way conduit in response to a signal from the water-level meter.

10. The apparatus for supplying a dampening solution for an offset printing machine according to claim 7, wherein the supply unit for supplying the dampening solution to the offset printing machine is provided with a one-way conduit connecting the mixing tank to a dampening fountain, a water-level meter for detecting water-level of the dampening solution in the dampening fountain, and a valve for additionally supplying the dampening solution to the dampening fountain by opening the one-way conduit in response to a signal from the water-level meter.

11. The method of supplying a dampening solution for an offset printing machine according to claim 2, wherein the dampening solution is additionally supplied to the offset printing machine by an amount corresponding to a consumed amount thereof through one-way manner.

12. The method of supplying a dampening solution for an offset printing machine according to claim 3, wherein the dampening solution is additionally supplied to the offset printing machine by an amount corresponding to a consumed amount thereof through one-way manner.
